(19) United States
(12) Patent Application Publication
(10) Pub. No.: US 2002/0166673 A1
(43) Pub. Date: Nov. 14, 2002

(54) Sprinkler having improved thermally responsive arrangement

(76) Inventor: George S. Polan, Perkiomenville, PA (US)

Correspondence Address: BAKER & BOTTS, 30 ROCKEFELLER PLAZA, NEW YORK, NY, 10112

(21) Appl. No.: 09/851,728

(22) Filed: May 9, 2001

(51) Int. Cl. A62C 37/08

(52) U.S. Cl. 169/37

(57) ABSTRACT

In the embodiments described in the specification, a fire protection sprinkler has a sprinkler body with an axial passage for a fire extinguishing fluid, a pair of frame arms terminating at a boss disposed on the axis of the sprinkler passage and a thermally responsive arrangement disposed between the outlet of the sprinkler passage and a screw extending through the boss. The thermally responsive arrangement includes a yoke unit having a yoke base received in a spring washer mounted at the outlet end of the passage and two spaced legs projecting parallel to the axis of the passage having pointed tips and a tubular strut unit having a base with a hemispherical projection engaging the screw and a strut having a cylindrical passage containing a plug of fusible material, a piston and a ball at the outer end which is received in a recess in the yoke base. The pointed tips of the yoke legs are received in recesses in the strut base member on a line which is laterally spaced from the axis of the sprinkler to provide a selected mechanical advantage which reduces the force applied to the plug of fusible material from the force applied between the screw and the spring washer to a level at which the load applied to the plug of fusible material is sufficient to assure prompt activation when the fusible material is fused while avoiding cold flow of the fusible material.

### BACKGROUND OF THE INVENTION

This invention relates to fire protection sprinklers and, more particularly, to thermally responsive arrangements for such sprinklers.

Various mechanisms have been used to detect the existence of elevated temperatures in fire protection sprinkler arrangements. In the Polan U.S. Pat. No. 4,957,169 a thermally responsive mechanism extends between the outer surface of a valve plug closing the passage in the sprinkler body and a parallel surface of a plate facing the valve plug which is supported by an abutment spaced from the plug. The thermally responsive mechanism includes a temperature sensor element and two support pins extending parallel to the temperature sensor element and disposed between the valve plug surface and the parallel plate surface so that, when the thermally responsive element is actuated, the support between the plate and the valve plug collapses, permitting the valve plug to be released.

In the arrangement described in that patent the surfaces of the plate and the valve plug are provided with three corresponding spaced recesses which receive the opposite ends of the temperature sensor element and the two parallel pins, respectively. The leverage produced by this arrangement, which reduces the force applied to the thermally responsive element, depends on the exact placement of the pins with respect to the thermally responsive element and of those components with respect to the axis of the sprinkler body.

The Barnett et al. U.S. Pat. No. 4,930,578 similarly discloses a sprinkler arrangement having a thermally responsive mechanism including a temperature sensor element with opposite ends received in recesses formed in components which are associated with a valve plug and with an abutment spaced from the valve plug, respectively.

The Griffith U.S. Pat. Nos. 2,165,477 and 2,245,144 disclose a sprinkler arrangement having a resilient strut valve seat with two arms on which a centrally disposed temperature sensor element is received at a location spaced laterally from the axis of the sprinkler, and the sprinkler arrangement disclosed in the Barz U.S. Pat. No. 2,664,956 has an axial strut which terminates in a temperature sensor element consisting of a fusible plug and a ball received in a recess in a valve cap along with spring members extending from the valve cap to laterally offset recesses in an upper portion of the strut member.

### SUMMARY OF THE INVENTION

Accordingly, it is an object of the present invention to provide a sprinkler having a thermally responsive arrangement which overcomes disadvantages of the prior art.

Another object of the present invention is to provide a sprinkler with a thermally responsive arrangement having a simple structure permitting convenient assembly.

These and other objects of the invention are attained by providing a sprinkler having a sprinkler body with a passage for fire extinguishing fluid with an outlet end, a pair of frame arms extending from the sprinkler body and forming an abutment spaced from the outlet of the sprinkler passage, and a thermally responsive arrangement extending between the outlet of the sprinkler passage and the abutment which includes a yoke unit having a base and two parallel legs projecting from the base and formed with tips which are offset from the sprinkler axis, and a strut unit having a base formed with recesses to receive the tips of the legs and including an axially extending tube containing a fusible material and a ball which is received in a recess in the base of the yoke unit.

The base of the yoke unit or the strut unit is supported by a spring washer received in a recess at the outer end of the passage and the base of the other of the two units is supported by the abutment which is spaced from the outer end of the passage. The fusible material supporting the ball fuses when the ambient temperature exceeds a selected value, permitting the ball to move into the tubular member in response to pressure applied by the spring washer so that the strut unit can pivot away from its axial disposition as a result of the offset engagement of the tips of the yoke legs with the base of the strut unit.

### BRIEF DESCRIPTION OF THE DRAWINGS

Further objects and advantages of the invention will be apparent from a reading of the following description in conjunction with the accompanying drawings in which:

FIG. 1 is a side view, partly in section, illustrating a representative embodiment of a sprinkler having a thermally responsive arrangement in accordance with the invention;

FIG. 2 is a view taken in longitudinal section along the line 11-11 of FIG. 1 and looking in the direction of the arrows; and

FIG. 3 is a schematic view, partly in section, showing the effect of the forces applied to the temperature sensing arrangement of the invention.

### DESCRIPTION OF PREFERRED EMBODIMENTS

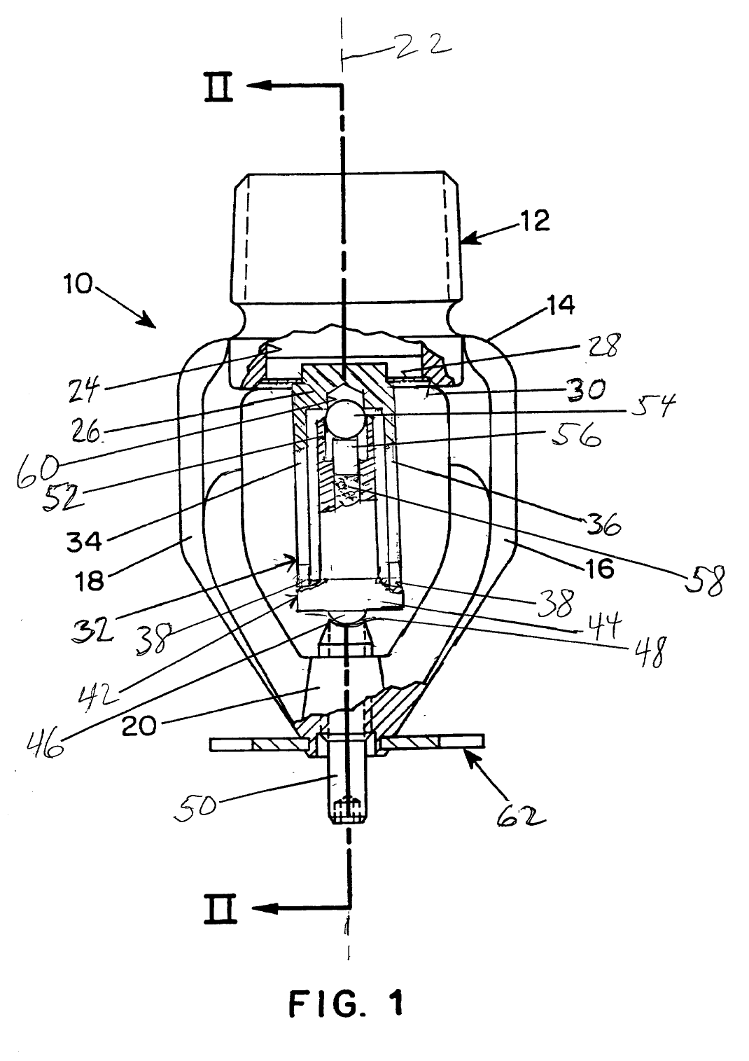

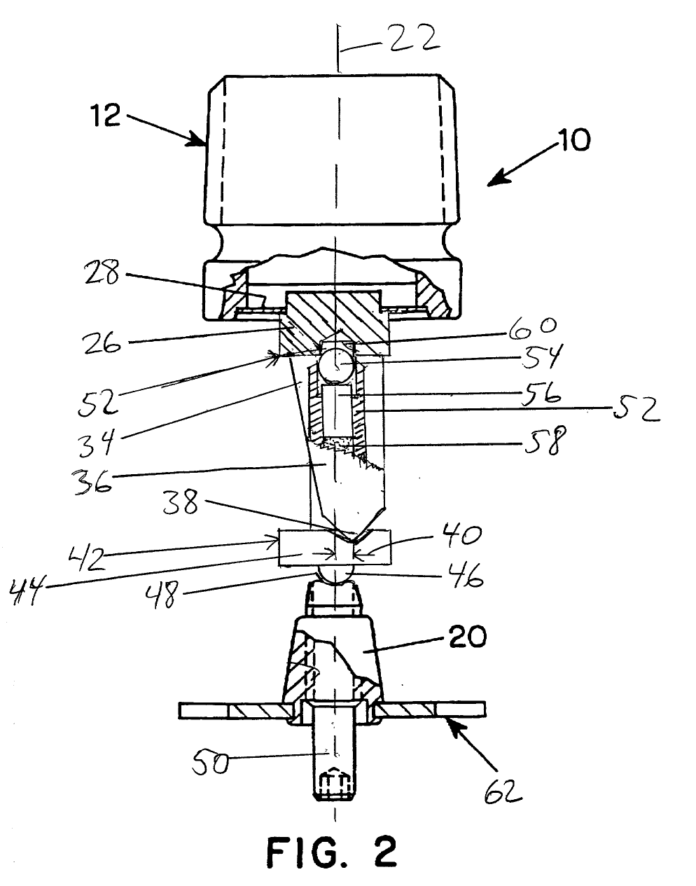

The typical embodiment of a sprinkler 10 according to the invention illustrated in FIGS. 1-3 has a threaded end 12 adapted to be connected to a pipe arranged to supply water under pressure and a frame 14 consisting of two arms 16 and 18 extending from opposite sides of the threaded end 12 and joined at a boss 20 which is positioned on the sprinkler axis 22 and spaced from the threaded end 12. The threaded end 12 is formed with an axial internal passage 24 to direct a stream of water under pressure axially toward the boss 20 and is normally closed by a yoke base 26 fitted into a spring washer 28 having its peripheral edge seated in a shoulder 30 at the outer end of the passage 24. The yoke base 26 is part of an integral yoke unit 32 which also includes two legs 34 and 36 extending from the yoke base 24 parallel to and on opposite sides of the axis 22 of the sprinkler. As best seen in FIG. 2, the legs 34 and 36 each taper to a tip 38 and a line joining the tips 38 is offset from the sprinkler axis 22 by a lateral spacing 40.

Cooperating with the yoke unit 32 is a strut unit 42 which includes a base 44 having an axial hemispherical projection 46 seated in a concave tip 48 of a screw 50 which is threaded through the boss 20 and an axially projecting tubular strut 52 containing a ball 54 supported in a projecting position at the outer end of the strut 52 by a slidable piston 56 backed by a plug of fusible material 58. The ball 54 is seated in a cylindrical axial recess 60 in the yoke base 26. A deflector 62, mounted on the outer end of the boss 20 extends in a plane perpendicular to the axis 22 of the sprinkler.

With this arrangement, the yoke base 26 and the spring washer 28 seal the outer end of the passage 24 and adjustment of the screw 50 in the boss 20 stresses the spring washer 28 to apply a desired axial force between the yoke base 26 and the hemispherical projection 46 of the strut unit 42. Because of the lateral spacing 40 between the point of engagement of the tips 38 of the legs 34 and 36 with the strut base 44 and the sprinkler axis 22 on which the ball 54 is received in the recess 60, a lateral force is applied between the strut unit 42 and the yoke unit 32 tending to pivot the strut unit away from the sprinkler axis 22. This pivoting motion is prevented as long as the ball 54 is retained in the cylindrical recess 60 of the yoke base 26.

When the ambient temperature increases to the fusing temperature of the fusible material 58, however, the piston 56 and the ball 54 are forced inwardly into the passage in the strut tube 52 by a force applied between the ball 54 and the edge of the opening 60 as a result of the axial force applied by the stressed spring washer 26. When the ball has moved inwardly into the strut tube 52 the strut can pivot away from its axial position in the yoke unit 32, causing the strut unit and the yoke unit to separate and permitting the yoke base 26 and the washer 28 to be forced out of the end of the passage 24.

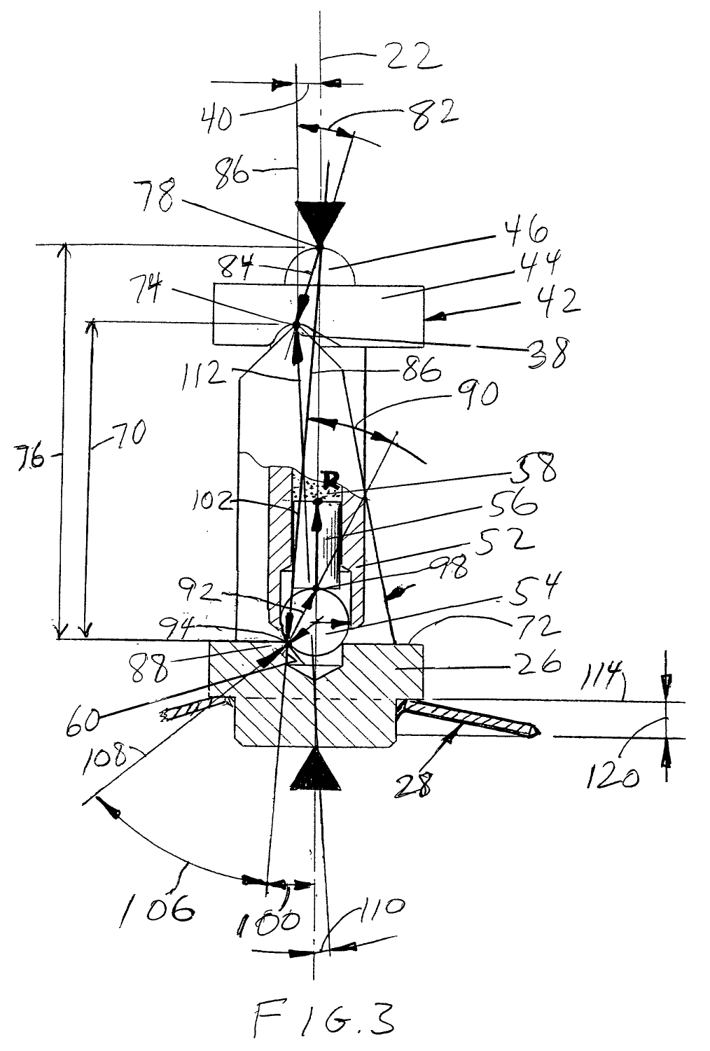

FIG. 3 illustrates the mechanical advantage produced by the thermally responsive arrangement of the invention, i.e., the reduction in the compressive load applied to the plug of fusible material 58 compared to the load applied between the screw 50 and the yoke base 26 of the yoke unit as a result of the offset 40 between the line joining the tips 38 and the sprinkler axis 22. In this illustration the axial distance 70 between the surface 72 of the yoke base 26 which receives the ball 54 and the contact point 74 of the tips 38 of the legs 34 and 36 with the strut base 44 is about 0.575 inch and the axial distance 76 between the surface 72 and the point of engagement 78 of the hemispherical projection 46 with the end of the screw 30 is about 0.705 inch while the lateral offset distance 40 is about 0.035 inch.

As a result, the angle 82 between a line 84 extending from the point of contact 74 of the offset tips and the contact point 78 of the hemispherical number with the screw and a line 86 parallel to the axis 22 is about 17° and the angle 90 between a line 92 from the contact point 94 of the ball 54 with the edge of the recess 60 and the axial contact point 98 between the ball 54 and the piston 56 is about 22° while the angle 100 between the axis 22 and a line 102 extending from the contact point 78 to the contact point 94 is about 4° and the angle 106 between the line 102 and a extension 108 of the radius of the ball 54 to the point 94 is about 45.5°. Moreover, the angle 110 between the axis 22 and a line 112 extending from the contact point 74 to the intersection of the axis 22 with the plane of support 114 of the yoke base 26 by the washer 28 is about 3.5°.

With this arrangement the mechanical advantage provided by the offset 40 is about 16.8 to 1, which means that, with 120 lbs. of assembly force applied at the point 78 to the hemispherical projection 46, only about 7.14 lbs. is applied at the point 94 radially inwardly on the ball 54 and only about half of that load is applied axially in the direction through the piston 56 to the face of the plug 58 of fusible material. This avoids any cold flow problem, assuring that the plug is maintained in a stable configuration, while also producing enough lateral load on the tube 52 to assure pivoting of the strut and consecutive ejection of the strut and yoke upon activation of the thermally responsive arrangement.

The lateral offset 40 between the line joining the tips 38 of the yoke legs and the axis 22 of the sprinkler is preferably more than about 0.015 inch and less than about 0.1 inch, depending on the length of the tube portion 52 of the strut unit. An offset distance 40 of about 0.015 inch produces mechanical advantage of about 38 to 1, resulting in a force applied to the plug 56 of about 3 lbs., which may not be sufficient to cause the fusible material to flow rapidly enough when fused to assure prompt release. On the other hand, an offset 40 of about 0.1 inch produces a mechanical advantage of about 5 to 1, resulting in a force of about 21. lbs. applied to the plug of fusible material which approaches a value capable of causing cold flow of that material.

Consequently, for a temperature sensor mechanism having the various dimensions described above, the offset distance 40 is preferably between about 0.02 inch and about 0.08 inch and desirably between about 0.025 inch and about 0.07 inch and the mechanical advantage is preferably in the range from about 30 to 1 to about 10 to 1 and desirably from about 13 to 1 to 25 to 1, restricting the force applied to the plug of fusible material to a value within a range preferably from about 3 lbs. to about 20 lbs., desirably from about 3.5 lbs. to about 15 lbs. and most desirably from about 4 lbs. to about 10 lbs.

The strut unit 42 is preferably made from a high grade copper based alloy for optimum heat transfer characteristics and the tube 52 has a precisely bored axial passage to accommodate the piston 56 and the ball 54. The piston 56 may be made of ceramic material, and the ball 52 may be of glass or ceramic material so as to be inert to corrosion and to minimize heat transfer away from the plug of fusible material 58, thereby causing the thermally responsive arrangement to be activated rapidly in comparison with conventional temperature sensor mechanisms.

The spring washer 26 is preferably a Belleville washer about 0.017 inch thick made of berylco nickel alloy 440 or brush wellman alloy 360 having an unstressed height 120 of about 0.041 inch and providing a nominal load of about 100 lbs. when compressed by about 0.017 inch to about 0.019 inch to a substantially flat configuration. This provides sufficient force to release the temperature sensor mechanism when the plug of fusible material fuses without requiring a supplemental spring to facilitate release. When assembled with the strut unit 32, the Belleville washer 26 becomes an integral part of the yoke base 26, thus assuring lodgment-free ejection of both parts when the sprinkler is activated.

Although the invention has been described herein with reference to specific embodiments, many modifications and variations therein will readily occur to those skilled in the art. Accordingly, all such variations and modifications are included within the intended scope of the invention.

I claim:

1. A sprinkler comprising:
a sprinkler body having a passage for fire extinguishing fluid with an outlet end and having a pair of frame arms extending from the sprinkler body and joined at a boss located on the axis of the sprinkler passage and spaced from the outlet end; and
a thermally responsive arrangement disposed between the outlet end of the sprinkler passage and the boss and including:
a strut unit having a strut base and a tubular strut extending from the strut base and disposed on the axis of the sprinkler passage, the tubular strut containing a plug of fusible material and a ball projecting from the end of the tubular strut;
a yoke unit having a yoke base with a recess in which the ball is received and a pair of legs extending from the yoke base on opposite sides of the tubular strut and terminating in tips engaging the strut base at locations on a line which is laterally spaced from the axis of the sprinkler passage; and
a spring washer supporting one of the strut base and the yoke base and sealing the outlet end of the sprinkler passage, the other of the strut base and the yoke base being supported by the boss.

2. A sprinkler according to claim 1 wherein the yoke base is supported by the spring washer and the strut base is supported by the boss.

3. A sprinkler according to claim 1 including a screw extending through the boss and engaging the base which is supported by the boss.

4. A sprinkler according to claim 3 wherein the base supported by the boss includes a hemispherical projection which is engaged by the screw.

5. A sprinkler arrangement according to claim 1 wherein the yoke base and the pair of legs are integrally formed and the strut base and the strut tube are integrally formed.

6. A sprinkler according to claim 1 wherein the spring washer, when compressed to a substantially flat condition, applies sufficient force to the thermally responsive arrangement to assure release of the strut unit from the yoke unit and ejection of the thermally responsive arrangement from the sprinkler when the plug of fusible material fuses.

7. A sprinkler according to claim 1 wherein the lateral spacing between the line of engagement of the tips of the legs of the yoke unit with the strut base and the sprinkler axis is selected to provide a mechanical-advantage between a force applied axially to the thermally responsive unit and a force applied to the plug of fusible material which is within the range from about 38 to 1 to about 5 to 1.

8. A sprinkler according to claim 7 wherein the lateral spacing is selected to provide a mechanical advantage in the range from about 10 to 1 to about 30 to 1.

9. A sprinkler according to claim 8 wherein the lateral spacing is selected to provide a mechanical advantage in the range from about 13 to 1 to about 25 to 1.

10. A sprinkler according to claim 1 wherein the lateral spacing between the line of engagement of the tips of the legs of the yoke unit with the strut base and the sprinkler axis is selected to reduce an axial force applied to a thermally responsive arrangement to a force applied to the plug of fusible material which is within the range from about 3 lbs. to about 20 lbs.

11. A sprinkler according to claim 10 wherein the lateral spacing is selected to produce a force applied to the plug of fusible material which is within a range from about 3.5 lbs. to about 15 lbs.

12. A sprinkler according to claim 11 wherein the lateral spacing is selected to produce a force applied to the plug of fusible material which is within a range from about 4 lbs. to about 10 lbs.

13. A sprinkler according to claim 1 wherein the tubular strut member comprises a copper based alloy providing optimized heat transfer characteristics.

14. A sprinkler arrangement according to claim 1 wherein the ball is made of a material having low heat transfer characteristics.

15. A sprinkler according to claim 14 wherein the ball is made of glass or ceramic material.

16. A sprinkler according to claim 1 including a piston disposed between the ball and the plug of fusible material and wherein the piston is made of ceramic material.

17. A thermally responsive arrangement for a sprinkler comprising:
a strut unit having a strut base and a tubular strut extending from the strut base, the tubular strut containing a plug of fusible material and a ball projecting from the end of the tubular strut;
a yoke unit having a yoke base with a recess in which the ball is received and a pair of legs extending from the yoke base on opposite sides of the tubular strut and terminating in tips engaging the strut base and locations on a line which is laterally spaced from the sprinkler passage; and
a spring washer received on one of the strut base and the yoke base and cooperating therewith to form a seal for a passage in sprinkler, the yoke unit, strut unit and washer being adapted to be subjected to an axial load when installed in a sprinkler to produce a lateral load urging the yoke unit and strut unit apart.

18. A sprinkler arrangement according to claim 17 wherein the yoke base and the pair of legs are integrally formed and the strut base and the strut tube are integrally formed.

19. A sprinkler according to claim 17 wherein the spring washer, when compressed to a substantially flat condition, applies sufficient force to the thermally responsive arrangement to assure release of the strut unit from the yoke unit and ejection of the thermally responsive arrangement from the sprinkler when the plug of fusible material fuses.

20. A sprinkler according to claim 17 wherein the lateral spacing between the line of engagement of the tips of the legs of the yoke unit with the strut base and the sprinkler axis is selected to provide a mechanical advantage between a force applied axially to the thermally responsive unit and a force applied to the plug of fusible material which is within the range from about 38 to 1 to about 5 to 1.

21. A sprinkler according to claim 20 wherein the lateral spacing is selected to provide a mechanical advantage in the range from about 10 to 1 to about 30 to 1.

22. A sprinkler according to claim 21 wherein the lateral spacing is selected to provide a mechanical advantage in the range from about 13 to 1 to about 25 to 1.

23. A sprinkler according to claim 17 wherein the tubular strut member comprises a copper based alloy providing optimized heat transfer characteristics.

24. A sprinkler arrangement according to claim 17 wherein the ball is made of a material having low heat transfer characteristics.

25. A sprinkler according to claim 24 wherein the ball is made of glass or ceramic material.

26. A sprinkler according to claim 17 including a piston disposed between the ball and the plug of fusible material and wherein the piston is made of ceramic material.
